(19) United States
(12) Patent Application Publication
(10) Pub. No.: US 2017/0090196 A1
(43) Pub. Date: Mar. 30, 2017

(54) VIRTUAL HEADS-UP DISPLAY APPLICATION FOR A WORK MACHINE

(71) Applicant: Deere & Company, Moline, IL (US)

(72) Inventor: Scott S. Hendron, Dubuque, IA (US)

(21) Appl. No.: 14/868,079

(22) Filed: Sep. 28, 2015

(51) Int. Cl. G02B 27/01; G06T 19/00

(52) U.S. Cl. CPC G02B 27/0172; G06T 19/006; G02B 2027/0141

(57) ABSTRACT

A head-mounted augmented reality device for an operator of a work machine is presented. The augmented reality device comprises a display component configured to generate and display an augmented reality overlay while providing the operator with a substantially unobstructed view. The augmented reality device also comprises a field of view component configured to detect an object within a field of view of the operator. The augmented reality device also comprises a wireless communication component configured to communicate with at least one information source. The augmented reality device also comprises a processing component configured to receive an indication from the at least one information source, and display the indication in association with the detected object.

### FIELD OF THE DESCRIPTION

The present invention relates to augmented reality devices. More specifically, the present disclosure relates to a heads-up display providing a view with an augmented reality overlay.

### BACKGROUND

In many industries, a variety of vehicles and work machines may be available for use by an operator, for example harvesters, tractors, or other exemplary vehicles. As these work machines have become more complex, monitors and displays have been incorporated into the vehicle cabin in order to display information about the various components of the vehicle. For example, information pertaining to the engine, information pertaining to the vehicle implement such as a blade height or a cut grade, as well as other information may all be important for an operator to have readily viewable. However, in order to view the information on the plurality of displays an operator typically needs to take his or her eyes off of the task they are performing to view the display. This may result in distraction, which may affect the work and potentially cause a danger to the operator and/or the vehicle.

In the past, some attempts have been made to display information in a non-distracting way. For example, machine-mounted heads-up displays may allow an operator to see pertinent information while they are looking at a work task, by displaying that information on an intervening surface. For example, in automobiles, this system works well to display odometer information because the operator is almost always looking in a constant direction: forward at the road ahead.

The discussion above is merely provided for general background information and is not intended to be used as an aid in determining the scope of the claimed subject matter.

### SUMMARY

A head-mounted augmented reality device for an operator of a work machine is presented. The augmented reality device comprises a display component configured to generate and display an augmented reality overlay while providing the operator with a substantially unobstructed view. The augmented reality device also comprises a field of view component configured to detect an object within a field of view of the operator. The augmented reality device also comprises a communication component configured to communicate with at least one information source. The augmented reality device also comprises a processing component configured to receive an indication from the at least one information source, and display the indication in association with the detected object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1A illustrates an exemplary wearable augmented reality device that may be useful in one embodiment of the present invention.

FIG. 1B illustrates an exemplary vehicle in which embodiments of the present invention are particularly useful.

FIG. 2 illustrates an exemplary computing device in accordance with one embodiment of the present invention.

FIGS. 3A-3D illustrate exemplary augmented reality views in accordance with one embodiment of the present invention.

FIG. 4 illustrates an exemplary method of displaying stored object information on an associated object in accordance with in one embodiment of the present invention.

FIG. 5 illustrates an exemplary method of displaying an indication on a viewed object in accordance with in one embodiment of the present invention.

FIG. 6 illustrates an exemplary method of providing an alert within a field of view of an operator in accordance with one embodiment of the present invention.

FIG. 7 illustrates an exemplary method of fixing object information on an associated object in accordance with one embodiment of the present invention.

### DETAILED DESCRIPTION

Augmented reality devices represent an emerging technology capable of providing more information to a user about the world around them. Different augmented reality devices exist in the art, for example an Oculus Rift headset, soon to be available from Facebook, Inc. of Delaware, which provides a fully virtual reality headset wearable by a user. Other manufacturers have incorporated an overlaid augmented reality on top of a view seen by a user, for example Google Glass, available from Google, Inc. of Delaware.

For operators of complex work machines, a multitude of information is available to an operator, from a variety of sources. Agricultural vehicles represent one category of work machines with which embodiments discussed herein may be useful. However, the embodiments and methods described herein can also be utilized in other work machines, for example in residential work machines, construction work machines, landscaping and turf management work machines, forestry work machines, or other work machines. For example, for an agricultural work machine, weather information may be important during planting and harvesting. Additionally, sensors on the vehicle may report important information for an operator, for example current speed and fuel level for a specific work machine, as well as statuses of different implements.

Some benefits of embodiments described herein is that a head-mounted display, described herein, can both allow an operator to have an unobscured field of view, while also having information relating to the work machine, and related implements presented in a useful, but non-distracting manner. Some embodiments described herein also selectively present information to an operator of a work machine relative to detected objects within a detected field of view. In one embodiment, the virtual information may be provided in a locked format such that the information appears to an operator as though it was generated by a portion of the device in their field of view. For example, it may be desired for information to appear similar to logos or other information presented on actual devices or device components such that the operator can perceive and process the information and such that any nausea or discomfort associated with traditional augmented reality devices is reduced.

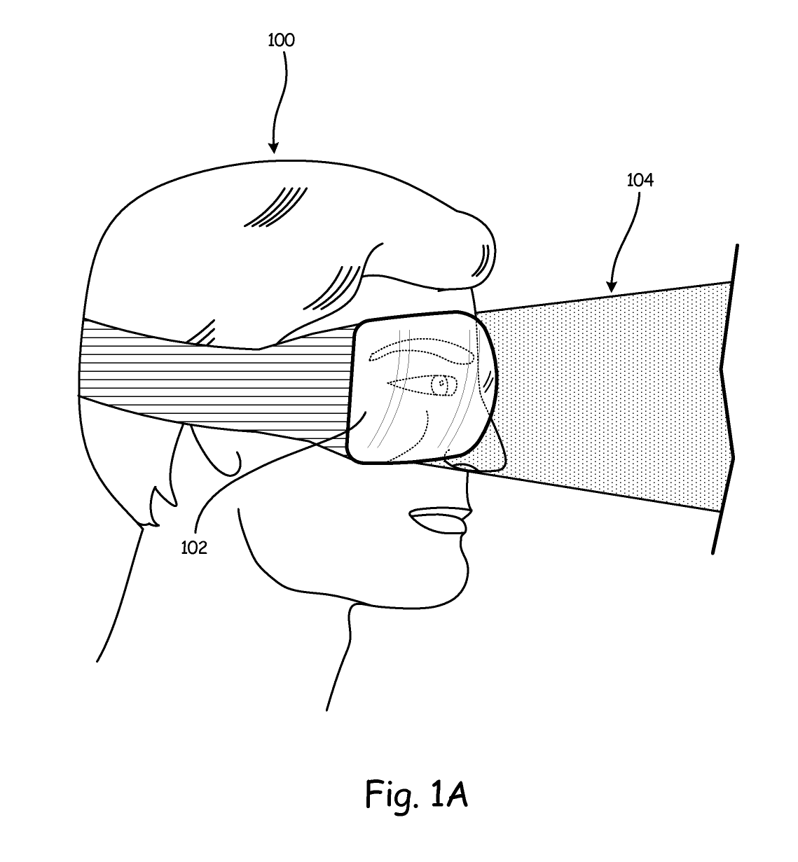

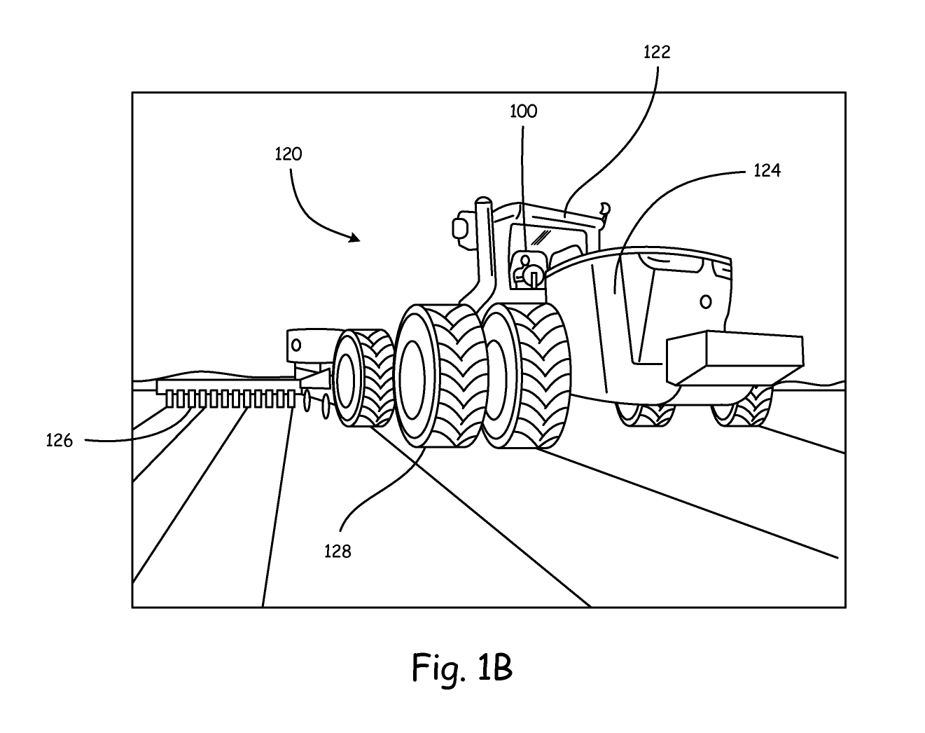

FIG. 1A illustrates an exemplary head-mounted augmented reality device that may be useful in one embodiment. As shown in FIG. 1A, it may be important that the operator 100 has a substantially unobstructed field of view 104 while wearing an augmented reality device 102. This is particularly important so that the augmented reality device 102 assists, and does not distract, an operator 100 operating a work machine. In one embodiment, the augmented reality device 102 may also be configured to provide some protection against ultraviolet rays, for example with at least partially tinted lenses. However, in another embodiment, the augmented reality device 102 is comprises a clear material, for example glass or a clear plastic.

FIG. 1B illustrates an exemplary vehicle in which embodiments of the present invention are particularly useful. In one embodiment, the vehicle is an agricultural machine 120, however other exemplary vehicles and work machines are also envisioned. Exemplary work machine 120 may comprise a plurality of implements with associated sensors, each of which may be collecting and providing information to an operator 100 seated within a cabin 122 of the work machine 120. The engine of machine 120 typically has a plurality of engine sensors 124, for example providing information about current engine temperature, oil pressure, fuel remaining, speed or other information. Additionally, the work machine 120 may have an implement, for example a harvester, a cutter, and/or a fertilized spreader implement with one or more implement sensors 126. The implement sensors 126 may collect information comprising, for example, a blade height for a cutter, an indication of a potential jam in a seeder row unit, current speed of a work machine, fuel remaining, weather-related information, or any other information relevant to the operator 100. Additionally, in one embodiment, the work machine 120 may have a plurality of wheels each of which may also have a plurality of wheel sensors 128 configured to collect and provide information about ground conditions or air pressure therein.

The work machine 120 may also be equipped with a plurality of cameras, or other sensors, which may be configured to collect and provide information to the operator 100 about conditions around the work machine. For example, operator 100 may, while operating the work machine 120 in a reverse direction, wish to be able to view the area directly behind them. A backup camera may provide such information. The backup camera, in conjunction with wheel sensors 128, and/or a steering wheel orientation, may provide an indication of which direction the work machine 120 may travel. All the information sources may be desired by an operator 100 at a given time. However, putting all this information on a single or even multiple displays may provide the operator with too much information to reasonably process without distraction.

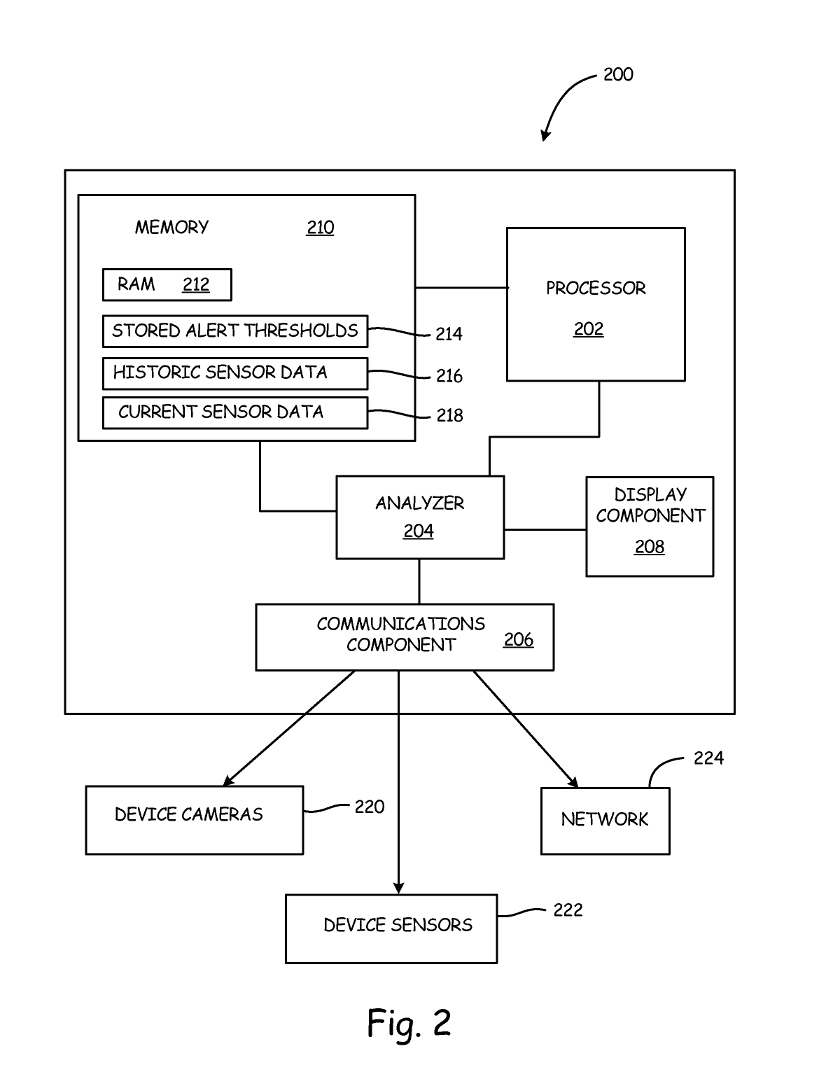

FIG. 2 illustrates a simplified block diagram of an exemplary computing device of a head-mounted display in accordance with one embodiment. The computing device 200 may comprise a processor 202, configured to process received information. The computing device 200 may also comprise an analyzer 204, configured to analyze raw sensor information, in one embodiment, in context with a detected field of view 104. The computing device 200 may also comprise, in one embodiment, a communications component 206 configured to receive information from, and communicate with a variety of sources. Additionally, the computing device 200 may also comprise a memory component 210 configured to store received raw and processed information.

The computing device 200 may, in one embodiment, receive information about an exemplary device, for example through the communications component 206. The information may pertain, for example, to functional components of work machine 120, or about an exemplary environment, for example weather and/or current soil conditions. The communication component 206 may be in constant, or intermittent communication, with a plurality of different sources. In one embodiment, the communications component 206 may obtain information about a machine 120 or its surroundings through a plurality of device cameras 220. In another embodiment, the communications component 206 may receive information about the machine 120 or its surroundings through a plurality of device sensors 222, for example engine sensors 124 as shown in FIG. 1B.

Communications component 206 may also, in one embodiment, be communicably connected to and receive information over a network 224. In one embodiment, when an operator 100 wearing an augmented reality device 102 encounters an object within their field of view, the augmented reality device 102 may not be able to readily identify the object, and communications component 206 may, through the connection to network 224, obtain an identification of the object.

In one embodiment, communications component 206 may provide at least some information obtained from any of sources 220, 222 and/or 224, to the analyzer 204. The analyzer 204 may be responsible for analyzing the received information from the communications component 206. The display component 208 may comprise a connection to the augmented reality device 102. For example, in one embodiment, the display component 208 may be able to determine a field of view 104 for an operator 100 based on sensory information or cameras within the augmented reality device 102. The analyzer 204 may, in one embodiment, identify one or more objects within the field of view 104. The analyzer 204 may also, in one embodiment, determine which information received through communications component 206 relates to the identified objects within field of view 104.

Information from one or more sources may be stored within memory 210, which may comprise both volatile memory, RAM 212, and non-volatile memory as well as a database of stored information. In one embodiment, memory 210 may contain historic sensor data 216, current sensor data 218, and one or more alert thresholds 214. For example, when analyzer 204 determines that an operator 100 has an engine component of an work machine 120 within field of view 104, the analyzer 204 may access stored historic sensor data 216 associated with the detected engine component. The analyzer 204 may, in one embodiment, provide the historic sensor data 216, in addition to current sensor data 216, for example received from device sensors 222, and display these through the augmented reality device 102. This may be useful to an operator 100 in order to determine whether the engine is approaching an overheat condition. A temperature indicating an overheat condition may be stored, for example within the stored alert thresholds portions 214 of the memory 210.

In one embodiment, computing device 200 is a component of the augmented reality device 102. In another embodiment, computing device 200 may be a component of the work machine 120. In another embodiment, at least a part of the computing device 200 may be a component of a processing component of work machine 120. For example, in one embodiment, the memory component 210 of an augmented reality device 102 may not store such information as, for example manufacturer set alert conditions such as overheat temperature and pressure for an engine, which are instead retrieved by communication component 206 communicating with a computing device associated with work machine 120.

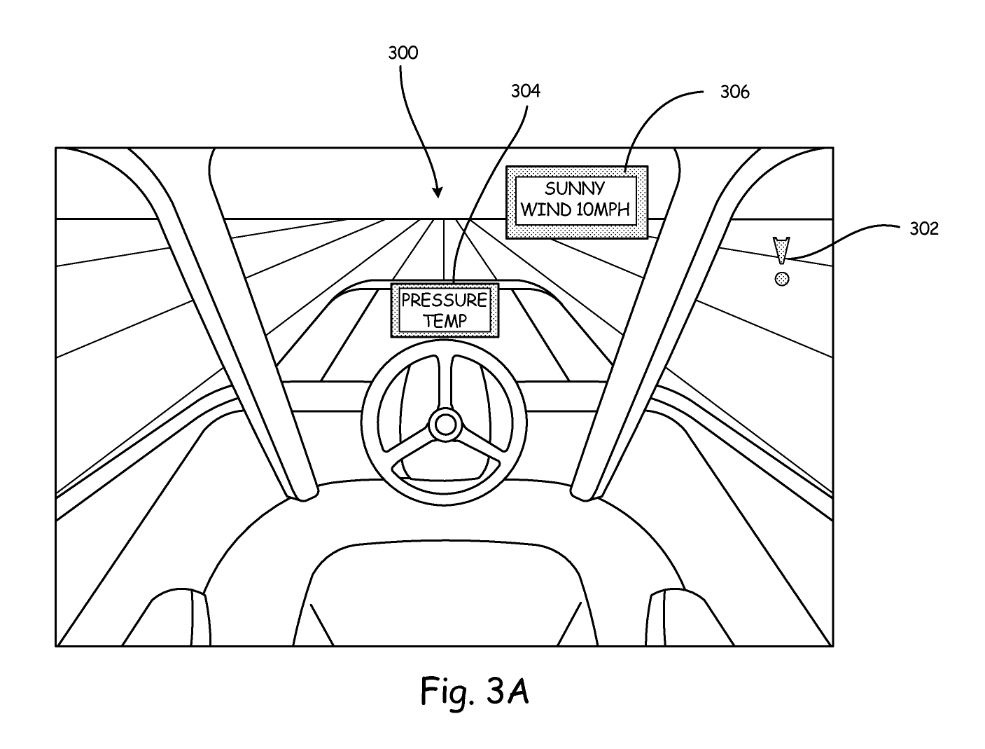

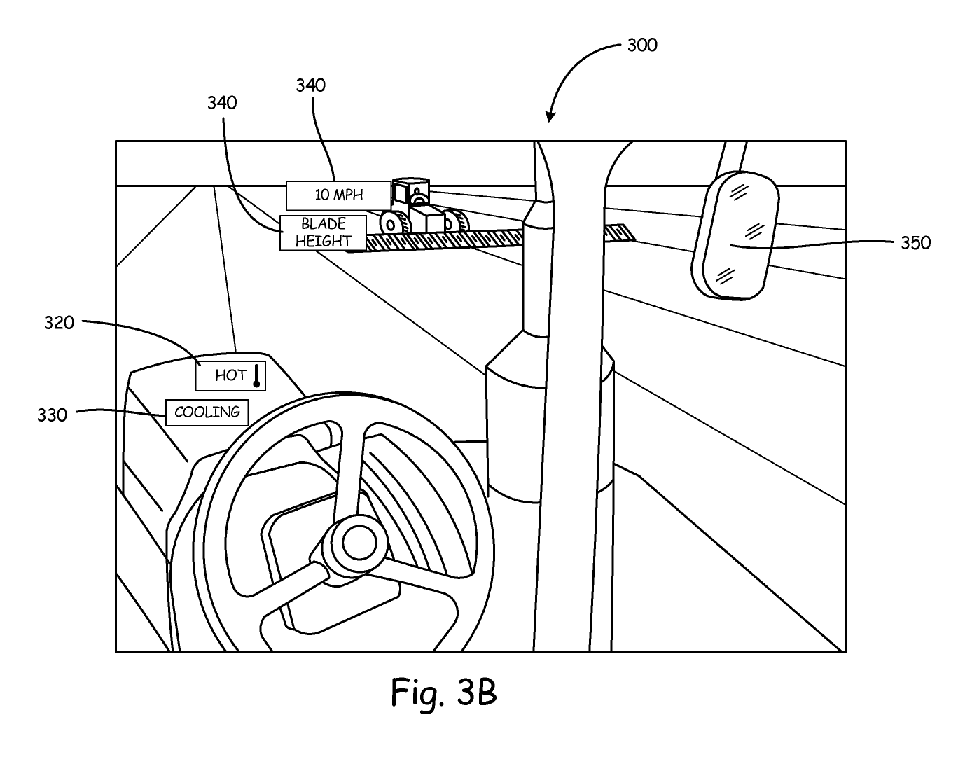

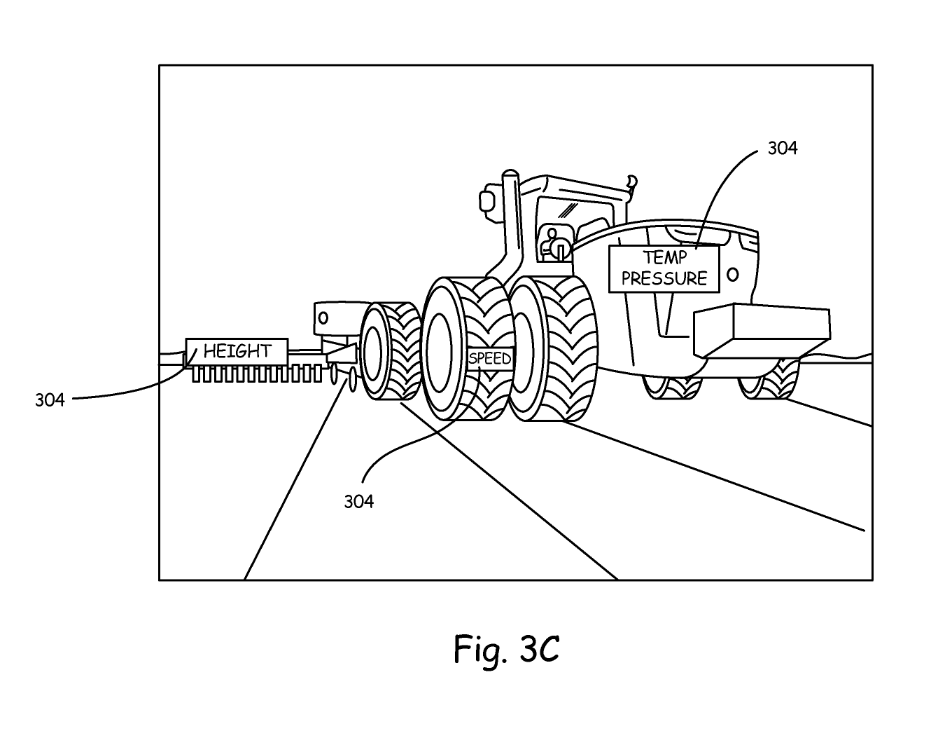

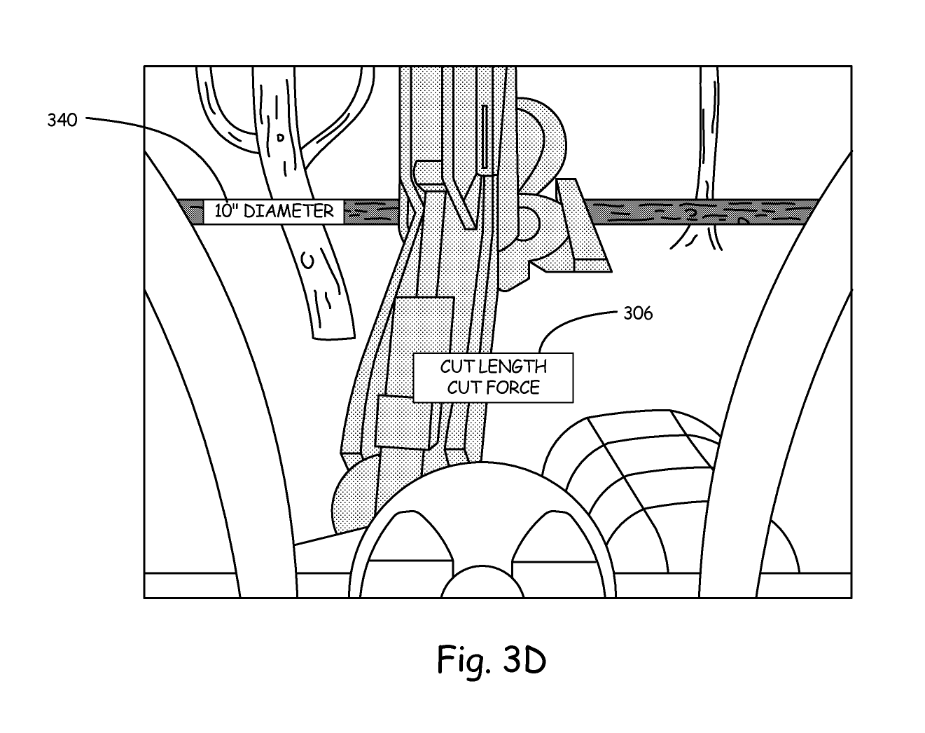

FIGS. 3A-3D illustrate exemplary augmented reality views in accordance with one embodiment. It may be important, in one embodiment, for an operator 100 to have a substantially unobstructed field of view 104 while operating an work machine 120. Previous augmented reality technology often presented information such that it appeared to be floating in space in front of the viewer. Such floating information within the center of a field of view may provide more distraction than utility to an operator, particularly if it obstructs potential hazards. Therefore, it is desired that at least some of the information presented through the augmented reality device 102 is presented such that it appears to be generated from, or locked onto, a portion of the component associated with that information.

FIG. 3A illustrates an overlaid reality view 300, that may be presented to an operator 100 when wearing augmented reality device 102. The operator 100 may see different portions of information presented within their field of view 104. This information may be presented in a variety of formats, for example as a floating indicator 302, a locked indicator 304, or a semi-locked indicator 306. In order to ensure operator 100 has a realistic experience wearing augmented reality device 102, the information displayed should, as best as possible, appear to be generated by the associated component, and not augmented reality device 102. Therefore, locked indicator 304 may appear to be generated by the engine.

As shown in FIG. 3A, locked indicator 304 shows a current pressure and current temperature related to the engine. This indicator 304 may be presented to an operator 100 such that it appears real, like a logo or paint actually on a surface of the engine. In one embodiment, locked indicators 304 appear to be a part of their surroundings, such that, if the operator 100 turns to the left or to the right the information appears to remain substantially in place.

In one embodiment, indicator 304 is presented to an operator as though it were part of the surface of the object, for example, like paint on an exterior of the engine. In another embodiment, indicator 304 is presented to an operator as though it were attached to a point on the object, for example past or predicted tread marks locked onto, and extending from, a tire. In another embodiment, indicator 304 is presented to an operator as though it were superimposed over the object, for example like a logo or a label. In another embodiment, indicator 304 is presented to an operator as though it were floating a specified distance from the object, for example, as though it were 5 feet in front of the vehicle.

Operator 100 may see other types of indicators in their field of view 104, for example a floating indicator 302 which may appear on a periphery of field of view 104. The floating indicator 302 may, therefore, not substantially obstruct a field of view 104, but may indicate that there is important sensor information that could be visible, for example by operator 100 turning to the right, as indicated by FIG. 3A. In a scenario where an alert threshold has been reached for a component outside of a current field of view 104, a floating indicator 302 may be important in order to direct attention of the operator 100 to where it is needed.

Additionally, augmented reality device 102 may also provide one or more semi-locked indicators 306. Semi-locked indicators 306 may appear to be locked onto a surface of a device, even though the information provided by semi-locked indicator 306 is not necessarily associated with the device surface. For example, as shown in FIG. 3A, the weather information provided in semi-locked indicator 306 appears to be locked onto a portion of the cabin window. Thus, if the operator 100 were to tilt their head so that they were looking further up, they may see the weather information come into the center of field of view 104, such that, if the operator 100 tilts their head down, the weather information may vanish from field of view 104.

FIG. 3B illustrates another exemplary overlaid reality view that may be presented to an operator in one embodiment. In FIG. 3B, the operator may view not only information pertaining to work machine 120, but also information pertaining to another object within field of view 104. For example, in FIG. 3B, operator 100 may see, within field of view 104, a seeder up ahead. Information pertaining to the seeder, since it is further away than information pertaining to the operator's device, may appear differently. In one embodiment, indicators presented by the augmented reality device may appear to be smaller if it relates to objects further away. In one embodiment, this may be shown by the distance indicators 340 associated with the seeder. These indicators may be presented with a smaller font than the alert indicator 320 and the trend indicator 330 that relate to components physically closer to the operator 100. The use of size differences in presenting information to operator 100, may allow for the experience to be more realistic, resulting in less distraction.

In one embodiment, operator 100 may interact with vehicle 120 through augmented reality device 102 and see indicators presenting different forms of information. In one embodiment, the operator may see an alert indicator 320 indicating that a sensor has received information pertaining to a potential problem with machine 120. For example, as shown in FIG. 3B, an alert indicator 320 may be presented on the engine of machine 120 indicating a potential overheating. The alert indicator 320 may, in one embodiment, be coupled with a trend indicator 330. The trend indicator 330 may indicate an historic trend of information from a sensor. So, as shown in FIG. 3B, while the engine may currently be in an overheat scenario, the current temperature is in a cooling pattern, indicating that operator intervention may not be needed.

Additionally, as shown in FIG. 3B, augmented reality device 102 may present one or more rear indicators 350. While sensors 222 may obtain information relating to objects in all 360° relative to the work machine 120, not all information may be displayable at once. In one embodiment, upon detecting that operator 100 is looking into a rearview mirror, augmented reality device 102 may display information about objects located substantially behind the operator 100. Displaying such information in a manner expected by the human brain, for example, in the rearview minor, may result in a more realistic experience with fewer distractions to operator 100.

In one embodiment, information provided by sensors 222 may be delivered to the augmented reality device 102 wirelessly. The ability to report information on machine components or parameters to the headset wirelessly may allow for operator 100 to continue to obtain updates about vehicle 120 after leaving the cabin. For example, in FIG. 3C, an operator has left the vehicle cabin and is now some distance away. In one embodiment, operator 100 may still be able to see a plurality of locked indicators 304. In one embodiment, the operator may be able to see that a cutting implement is at a certain height above the ground, and that an engine exhibits a certain temperature and pressure.

FIG. 3D illustrates an exemplary augmented reality overlay for an operator 100 viewing a cut-to-length harvester. In one embodiment, a cut-to-length harvester may take hold of a tree for harvesting. To an operator in the cab of a cut-to-length harvester, there is a lot of relevant information that is, currently, often displayed on monitors to the side of an operational field of view. For example, parameters related to the tree being harvested, such as tree diameter and harvest length as well as information relating to the harvester blade, such as cut length and grade may be more useful if presented within the field of view 104 of the operator 100.

In one embodiment, by utilizing a wearable augmented reality device during operation of the cut-to-length harvester, information may be displayed by locked indicators 306 directly within field of view 104. In one embodiment, information pertaining to the tree may be displayed with a distance indicator 340 that appears to be locked onto the tree itself, but uses smaller text to indicate that the tree is at a distance from operator 100. Additionally, there may be one or more locked indicators 306 corresponding to information about the cut-to-length harvester, for example those shown in FIG. 3D indicating a current cut length and grade of a cut-to-length harvester.

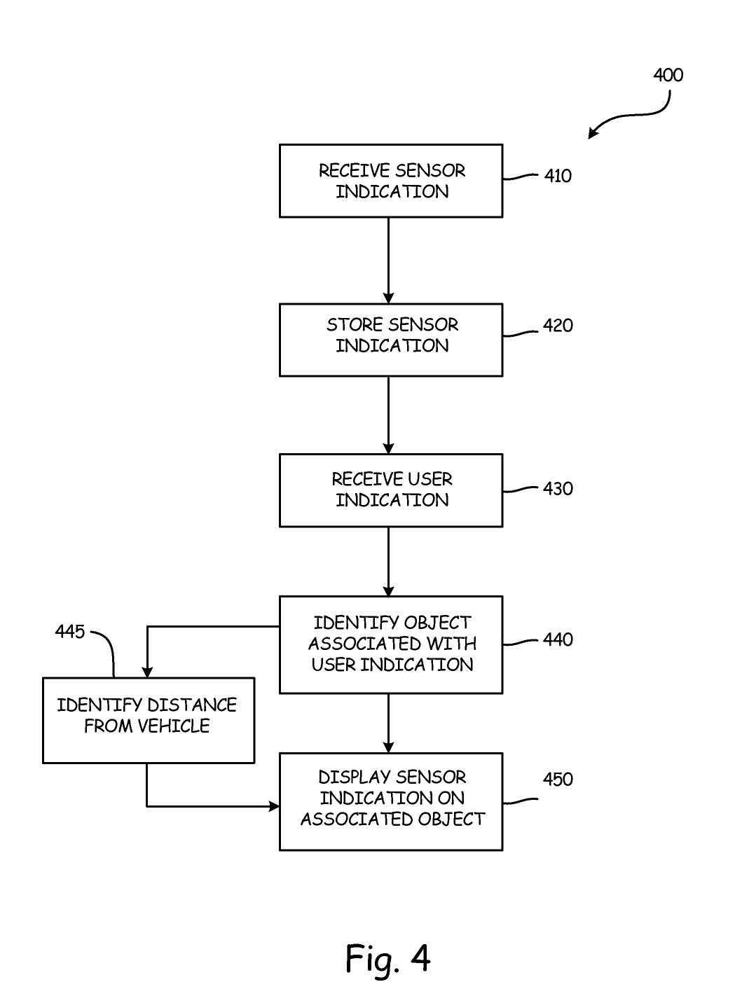

FIG. 4 illustrates an exemplary method of displaying stored object information on an associated object in accordance with in one embodiment. The augmented reality device may be able to, through method 400, retrieve and display stored sensor information to an operator upon detection of a relevant object within field of view 104. In one embodiment, the stored information may be historical trend data, historical alert data, or previously retrieved sensor information pertaining to the object.

In block 410, an exemplary computing device, for example, device 200, receives a sensor indication. The sensor indication may come from any of a plurality of sensors related to the device, and may pertain to engine information, implement information, operator information, and/or any other relevant information, for example weather information. In one embodiment, information is passively received by the computing device 200 regardless of an immediate relevance to a current detected field of view 104. In another embodiment, information is actively collected based on identified objects within the current field of view 104.

In block 420, received sensor information is stored. Such storage may include indexing the sensor information by relevant object. In one embodiment, storage comprises indexing the sensor information based on a field of view in which the information can be presented, for example viewing the object directly, or viewing the object in a rearview mirror. This information may be stored, for example within memory 210. It may be stored, in one embodiment, in a memory associated with a computing device onboard the work machine 120. However, in another embodiment, it may be stored within a memory associated with the augmented reality device 102. The sensor information may be stored within a computing device on an exemplary agricultural machine and then be relayed, such that the augmented reality device 102 is only in direct communication with a computer onboard the work machine 120, and not in direct communication sensors. In another embodiment, the sensor information is received directly by augmented reality device 102, which then indexes and stores the information in an internal storage for later retrieval.

In block 430, a user indication is received. The user indication may include detection of a change in the field of view 104. For example, the augmented reality device 102 may receive an indication that operator 100 has turned their head a number of degrees to the left or the right, changing at least a part of the field of view 104. The detection may be facilitated, in one embodiment, by one or more accelerometers within the augmented reality device 102. The detection may, in one embodiment, be facilitated by a plurality of cameras associated with augmented reality device 102. Additionally, the indication may comprise detection of a change in the position of the work machine 120. As work machine 120 moves, a field of view 104 of operator 100 will change, as objects move in and out of the field of view 104.

In addition to receiving information about a current field of view 104, in block 430, the augmented reality device may also receive an audible request from the user. For example, in one embodiment, augmented reality device 102 may be able to detect and process an audible command, such as a question, “what is the current engine temperature?” or a command “show hourly weather forecast.”

In block 440, the augmented reality device 102 may identify an object associated with the received user indication. For example, in an embodiment where the user indication is an audible request for an updated engine temperature, the augmented reality device 102 may identify that the engine is the object associated with the user indication. In another embodiment, where the user indication is a detection that a field of view has changed, such that a new device or device component is now within field of view 104, the augmented reality device may detect that the newly viewable object corresponds to a cutting implement. The method 400 may determine, initially, whether a relevant object surface is within a current field of view 104. If there is no relevant object within a current field of view 104, another appropriate surface, for example a dashboard, or a cabin window may be selected instead. Additionally, if the relevant object is substantially behind the operator 100, the rearview mirror surface may be selected. If no appropriate surface is available, a floating indicator 302 may be used in order to guide an operator 100 to the newly available information. In another embodiment, the operator 100 may be able to select a surface, either by an indication such as “display weather information on cabin window” or through a pre-selection process.

In one embodiment, information identifying the object, and sensor signals concerning the object, are drawn from different sources. For example, sensor signals may be periodically received from device sensors, or from memory as required. Object identification, however, may be retrieved from an external source, for example the Internet. The object may be identified, for example, by the augmented reality device 102 capturing indications of potential objects within a field of view 104 and send the captured indications to analyzer 204. If analyzer 204 cannot readily identify the captured indication as an object, for example by accessing memory 210, the captured indication may be sent to an external processing component (not shown), by communications component 206, over a network 224. The external processing component may identify the indication as an object of interest, and send an identification of the object back to the augmented reality device 102. In one embodiment, the external processing component may also identify potentially relevant sensor signals, for example after identifying an object as a storage tank, volume and/or weight may be indicated as relevant sensor signals.

In another example, the indicated object may be identified as a work tool associated with an agricultural vehicle and an indicated relevant sensor signal may be a distance above ground level. The augmented reality device 102 may, then, superimpose a retrieved distance from the ground over an identified linkage between the work tool and the work machine 120. In one embodiment, the retrieved distance from ground is a dynamic measurement as, for example, the work tool may be in motion with respect to the ground at a given time.

In another example the position of the image overlay is selected based on sensor signals associated with the vehicle 120, instead of an image processing component. For example, field of view 104 may have the vehicle 120 at a reference position of 0°, and a sensor associated with an implement at a position 45° to the right of operator 102. Upon detecting a change in field of view 104 corresponding to operator 102 turning 45° to the right, sensor information pertaining to the implement can be displayed in an image overlay over the implement.

In block 450, the augmented reality device may display appropriate sensor information on the associated object. In an embodiment where the newly detected object is a cutting implement, relevant sensor information, such as blade height and speed may be displayed such that they appear to be fixed on the cutting implement. The information displayed in block 450 may be updated as new sensor information is received. For example, if the cutting implement is moving into place, the displayed height may be updated as the implement moves. In one embodiment, the displayed information is only updated periodically, for example once per second. In another embodiment, the displayed information is updated in real-time as new sensor information is received. However, in one embodiment, where multiple sensors are reporting real-time information, different indications may be updated at different rates. For example, method 400 may determine that, since the cutting implement is moving based on actions by the operator, its associated displayed information may be updated in real-time whereas other information, for example pertaining to current engine temperature, may be updated less frequently. Constant updating of all sensor information may be overwhelming to an operator 100, and distracting. Having different update rates for information important to a detected task and other information may provide a less distracting experience.

In one embodiment, in block 445, a distance between operator 100 and the relevant object is determined. Upon detecting that the newly identified object is a certain distance away from operator 100, the display step in block 450 may display the sensor information in a smaller or larger text, as appropriate. For example, information relating to object more than 10 feet from operator 100, may be in a smaller text than information displayed to operator 100 as fixed on a cabin window, for example.

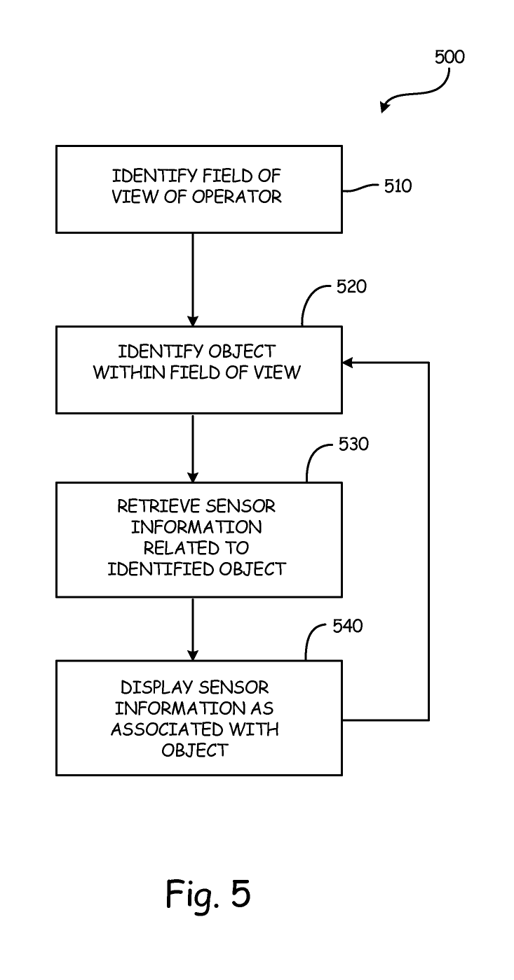

FIG. 5 illustrates an exemplary method of displaying an indication on a viewed object in accordance with in one embodiment. In an embodiment where sensor information is stored in a memory remote from augmented reality device 102, it may not be retrieved until an associated object has been detected within field of view 104.

In block 510, an augmented reality device identifies a field of view for operator 100. The field of view 104 may be identifiable based on cameras associated with augmented reality device 102. Additionally or alternatively, field of view 104 may be determined based on internal accelerometers. In another example, augmented reality device 102 may undergo a calibration period for each anticipated operator, such that augmented reality device 102 can accurately perceive a field of view 104 and detect which objects an operator perceives.

In block 520, augmented reality device 102 identifies an object as within field of view 104. Identification of an object may include, for example, determining that a known object is within field of view 104. For example, augmented reality device 102, in communication with an exemplary work machine, may be able to identify different objects associated with the work machine, for example an implement, an engine, and/or a dashboard. In another embodiment, however, the augmented reality device may be able to identify an object based on a catalog of known objects, or by accessing a network, for example the Internet, to determine a potential identification of a detected object. For example, as illustrated in FIG. 3D, augmented reality device 102 may be able to identify an object held by the cutting implement as a tree.

In block 530, augmented reality device 102 retrieves sensor information related to an identified object. In one embodiment, receiving sensor information comprises retrieving a last captured sensor reading. For example, if a sensor is configured to report engine temperature once every five seconds, retrieving sensor information may comprise retrieving and displaying an engine temperature from, for example three seconds prior, as that is the most recent sensor information available. In another embodiment, retrieving sensor information comprises sending a command to the sensor to take and report back a current sensor reading.

In block 540, the retrieved sensor information, in one embodiment, is displayed by augmented reality device 102 such that it appears to be associated with the identified object. In one embodiment, this comprises displaying the sensor information such that it appears to be locked onto the associated object. In another embodiment, this may comprise displaying sensor information so that it appears to be semi-locked, for example through a rear indicator 350 on a rearview mirror within field of view 104. Method 500 may cycle through the steps described above with respect to blocks 520, 530, and 540 for as many objects as are detected within field of view 104.

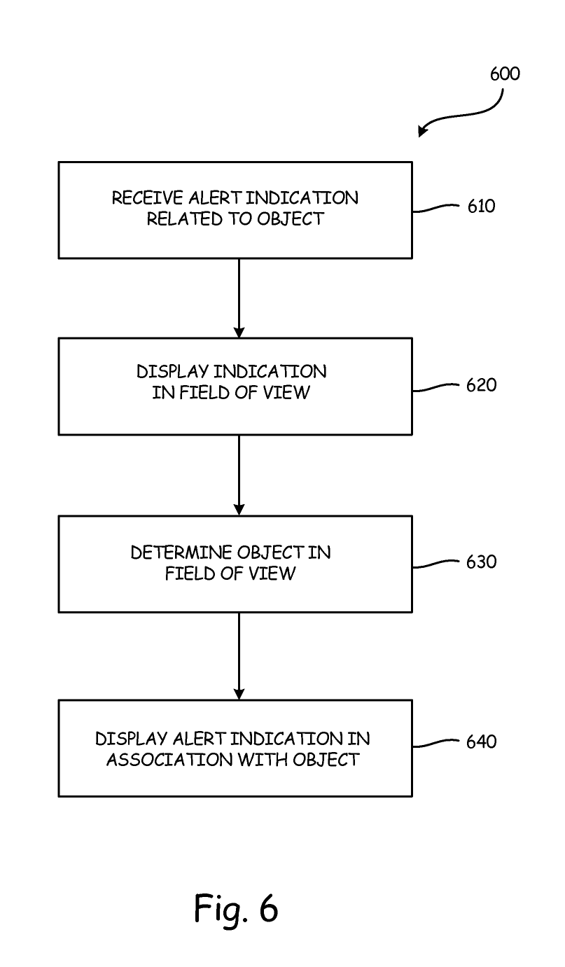

FIG. 6 illustrates an exemplary method of providing an alert within a field of view of an operator with one embodiment. It may be important, to provide operator 100 with alert information, even if the object triggering the alert is not in field of view 104. However, it is extremely important to ensure that the alert is conveyed such that it draws the attention of operator 100, without distracting them from a current task. Therefore, it may be desired for the alert to appear within field of view 104, but not in the center of field of view 104. For example, it may be useful for method 600 to display the alert in a periphery of field of view 104.

In block 610, in one embodiment, augmented reality device 102 receives an alert indication relative to an object. For example, sensor information may be received indicating that an engine is overheating, or that a row unit of a seeder is experiencing a jam. This alert indication may be received, for example, in one embodiment, even though the exemplary engine or row unit is not within field of view 104. However, the alert may be important, such an indication should be provided before operator 100 next encounters the relevant object within field of view 104.

In block 620, in one embodiment, an indication is displayed within field of view 104. The indication may be displayed, in one embodiment, in the peripheral edges of field of view 104 so as to draw attention, but minimizing distraction to operator 100. For example, as shown in FIG. 3A by floating indicator 302, an alert indication may be displayed such that it appears to be generated by an object within peripheral view of operator 100. The human brain is accustomed to perceiving information with on the periphery of their field of view, for example somebody waving to catch a person's attention. Upon seeing an indication on the peripheral edges of their view, operator 100 may then turn their head in order to more accurately perceive the source of the peripheral indication. This may allow for an operator to easily perceive that an alert has been triggered, without providing a distraction or a non-realistic environment.

In block 630, in one embodiment, augmented reality device 102 detects a relevant object within field of view 104. This may occur, for example, as augmented reality device 102 detects movement of operator 100 turning in the direction of the peripherally located alert. It may also occur, for example, as augmented reality device detects movement of the object into field of view 104.

In block 640, in one embodiment, the alert information is displayed in association with the object within field of view 104. The alert information is displayed such that it appears to be locked onto the object associated with the alert. In one embodiment, the object is a significant distance from the operator, and the alert information is displayed in a smaller font to reflect the distance, but in a significant format in order to draw the operator's attention.

In one embodiment alert information is displayed in bold font or a brightly colored font, for example red or green. The alert may also be otherwise distinguished, for example as highlighted text, or as a non-text based indicator. In one embodiment, the augmented reality device 102 detects a color of the relevant object, and display the alert information in a complementary color. For example, against a green background, alert information may appear red. For example, against an orange background, alert information may appear blue. This may assist operator 100 in quickly identifying, and responding to, the generated alert.

In one embodiment, method 600 may also provide alert information that is not generated by an object. For example, the alert information may come from an external source, such as an application accessing the Internet. In one embodiment, operator 100 may need to be aware of upcoming weather trends, such that equipment can be stored prior to a storm arriving. In another embodiment, operator 100 may need to be aware of detected subterranean obstacles, such as utility lines. The alert indication may be received over a network and displayed to operator 100, for example using any of methods 400, 500 or 600.

Additionally, while block 620 contemplates an embodiment where the indication is displayed within field of view 104, it is also contemplated that the indication could be an audible indication. For example, augmented reality device 104 may have one or more speakers configured to be positioned about the head of operator 100. If an alert indication relates to an object behind and to the left of operator 100, a speaker located on the augmented reality headset substantially behind and to the left of operator 100 may indicate an alert. This may be a less distracting way to indicate to the operator that alert information is available outside of their field of view while also providing a directional indication of the alert. It may also be a selectable feature, for example, for operators with impaired peripheral vision.

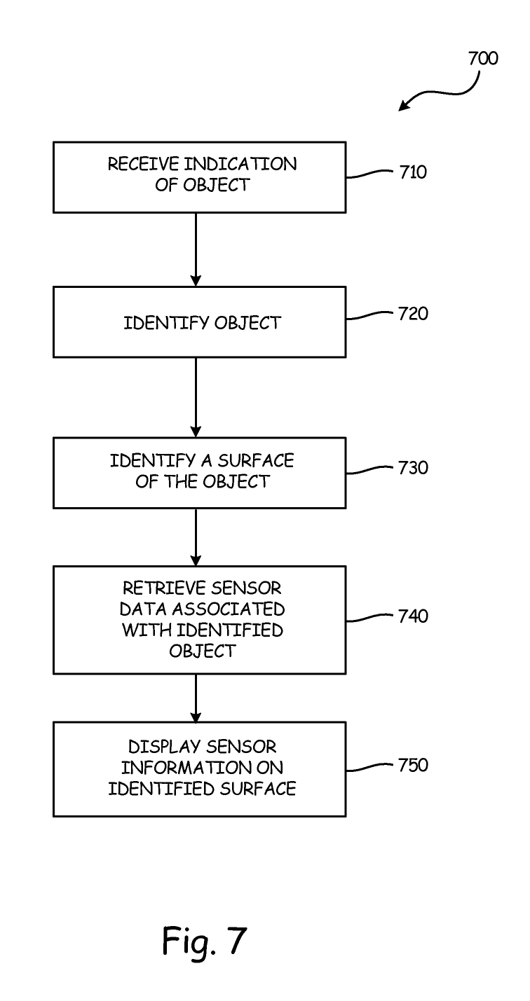

FIG. 7 illustrates an exemplary method of fixing object information on an associated object in one embodiment. It is important that information is displayed to an operator in such a manner as to not distract the operator from a current task. One of the most efficient and effective ways to accomplish this is to present the information such that it appears to be generated by, or locked onto, the object associated with the information. Method 700 illustrates an exemplary method for displaying such fixed information to operator 100.

In block 710, an indication of an object is received by augmented reality device 102. The indication of the object may be an indication of an unexpected object within the field of view, in one embodiment. In another embodiment, the indication of the object is an indication of an expected object, for example a known implement of an work machine 120.

In block 720, the indicated object is identified. The object may be identified based on a plurality of sources, for example, augmented reality device 102 may recognize a plurality of objects associated with a typical agricultural implement using image processing techniques. In another embodiment, augmented reality device 102 may be connected to a network such that it can cross-reference a viewed object with a stored index of identified objects, in order to identify the indicated object.

In block 730, a surface of the object is identified. The augmented reality device may highlight an entire object, and determine a best surface for presentation. In one embodiment, the best surface of an object is one that appears to be flat to an operator. However, a curved surface may also be acceptable, and augmented reality device 102 may adjust displayed information to match detected curvature. For example, in looking at a bucket or storage tank, the surface may appear curved to the operator, but may be substantially flat enough to display information associated with a weight or volume, in one embodiment.

In block 740, sensor information associated with the identified object is retrieved. In one embodiment, the sensor information is retrieved by accessing the latest set of sensor information, for example from historical sensor data 216. In another embodiment, sensor information is retrieved by sending a command to the sensor(s) associated with the identified object to return a most recent sensor reading(s).

In block 750, sensor information is displayed by augmented reality device 102 such that it appears fixed on the identified surface. As augmented reality device 102 detects movement of operator 100, for example turning to the left or the right, the sensor information is updated on the display such that it appears not to move on the surface of the object regardless of movement of operator 100.

The present discussion has mentioned processors and servers associated with either or both of augmented reality devices and/or work machines, including, in some embodiments, agricultural devices. In one embodiment, the processors and servers include computer processors with associated memory and timing circuitry, not separately shown. They are functional parts of the systems or devices to which they belong and are activated by, and facilitate the functionality of the other components or items in those systems.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will also be noted that any or all of the information discussed as displayed or stored information can also, in one embodiment, be output to, or retrieved from, a cloud-based storage.

It will also be noted that the elements of FIG. 2, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc. These devices can also include agricultural vehicles, or other implements utilized by an exemplary operator.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A head-mounted augmented reality device for an operator of a work machine comprising:
a display component configured to generate and display an augmented reality overlay while providing the operator with a substantially unobstructed view;
a field of view component configured to detect an object within a field of view of the operator;
a communication component configured to communicate with at least one information source; and
a processing component configured to receive an indication from the at least one information source, and display the indication in association with the detected object.

2. The augmented reality device of claim 1, wherein the communication component is a wireless communication component.

3. The augmented reality device of claim 1, wherein the processing component is configured to determine that the indication is associated with the detected object.

4. The augmented reality device of claim 1, wherein displaying the indication in association with the detected object further comprises displaying the indication as though it were a part of a surface of the detected object.

5. The augmented reality device of claim 4, wherein the displaying the indication as though it was part of the surface of the detected object further comprises displaying the indication as though it were attached to a point on the object.

6. The augmented reality device of claim 4, wherein displaying the indication as though it were part of the surface of the detected object further comprises superimposing the indication over the object.

7. The augmented reality device of claim 4, wherein displaying the indication as though it were part of the surface of the detected object further comprises displaying the indication as though it were floating a specified distance from the object.

8. The augmented reality device of claim 7, and further comprising memory configured to store received indications such that the indications are indexed with at least one of:
an associated object; and
a field of view angle.

9. A method for displaying received information with an augmented reality device, the method comprising:
receiving, from an information source, an indication of information relative to an operation relative to a work machine;
receiving, through a receiver, a user indication;
identifying, utilizing a processing component, an object associated with the user indication; and
displaying, utilizing a display component, the received indication such that it appears locked on the identified object.

10. The method of claim 9, wherein the information source is a first information source, and wherein the display component is configured to access a second information source configured to receive information regarding a location, within a field of view of the augmented reality device, for the received indication.

11. The method of claim 9, wherein the processing component is external from the augmented reality device, and wherein identifying the object associated with the user indication comprises:
sending an indication of a potential object to the external processing component; and
receiving, from the remote processing component, an identification of the object.

12. The method of claim 9, wherein the processing component is part of the augmented reality device.

13. The method of claim 9, wherein the received user indication comprises detecting, utilizing a positioning component of the augmented reality device, that a field of view has changed.

14. The method of claim 9, wherein the indication of information comprises a dynamic measurement regarding a component of the operation.

15. The method of claim 9, and further comprising:
detecting a distance between the object and the augmented reality device and wherein displaying the received indication further comprises sizing the received indication based on the detected distance.

16. The method of claim 14, wherein the component comprises a work tool, the dynamic measurement comprises a distance of the work tool from a ground level, and wherein the display component identifies a linkage of the work tool to the work machine and displays the distance of the work tool from a ground level such that it appears superimposed over the linkage.

17. The method of claim 9, wherein displaying the received indication further comprises:
identifying a surface of the object; and
displaying the received indication such that it appears to be a part of the identified surface.

18. A method of displaying information on an object with a head-mounted augmented reality device, the method comprising:
identifying, utilizing the augmented reality device, a field of view associated with the augmented reality device;
identifying, utilizing a processing component, an object of interest within the field of view of an operator of a work machine;
retrieving an indication of information associated with the identified object, wherein the indication of information comprises a dynamic measurement regarding the identified object;
displaying the indication of information, utilizing a display component of the augmented reality device, wherein displaying comprises portraying the indication of information as though it is locked onto a surface of the object.

19. The method of claim 18, wherein identifying a field of view comprises detecting a field of view of an operator wearing the augmented reality device utilizing a positioning component of the augmented reality device.

20. The method of claim 18, wherein the indication of information is received information from a sensor associated with a vehicle, wherein the indication of information comprises a status of a component of the vehicle.
